(19) United States
(12) Patent Application Publication
(10) Pub. No.: US 2021/0253472 A1
(43) Pub. Date: Aug. 19, 2021

(54) TEXTURED GLASS PANEL AND INSULATION FOR A GREENHOUSE

(71) Applicant: SAINT-GOBAIN GLASS FRANCE, COURBEVOIE (FR)

(72) Inventors: Michele SCHIAVONI, PARIS (FR); Vincent REYMOND, ANTONY (FR)

(21) Appl. No.: 17/269,458

(22) PCT Filed: Aug. 2, 2019
(86) PCT No.: PCT/FR2019/051897

§ 371 Date: Feb. 18, 2021

(30) Foreign Application Priority Data
Aug. 31, 2018 (FR) 1857831

(51) Int. Cl. C03C 17/36; C03C 17/32

(52) U.S. Cl. CPC C03C 17/3681; C03C 17/3644; C03C 17/32; C03C 2218/33; C03C 2217/256; C03C 2217/73; C03C 2217/77; C03C 2217/213

(57) ABSTRACT

A glazing, comprising a glass substrate on which is deposited in succession, from a first surface of said substrate:
a first coating comprising a layer having infrared-reflecting properties or a set of layers, at least one layer of which has infrared-reflecting properties,
a second coating on top of said first coating comprising an organic or mineral layer, said second coating having a relief texture, said texture being such that its mean slope Pₘ is less than or equal to 15°, and the percentage of the textured surface having a slope of greater than 5° is greater than 5%.

The invention relates to the field of scattering and highly transparent glazings, in particular for the manufacture of horticultural greenhouses.

Currently, flat glazings not textured at the surface are predominantly used for forming greenhouses used for horticulture.

However, for some years, glazings for horticultural greenhouses have been becoming increasingly technical products. Specifically, very particularly in temperate climates, the productivity of the greenhouse increases in proportion to the solar radiation that the plants receive, in particular during periods with a low amount of sunshine.

Furthermore, a diffuse transmission of the incident sunlight through the glazing of the greenhouse makes it possible to significantly increase the productivity. It follows that glazings which have both a high light transmission and a high scattering of the incident light (measured by the degree of haze) are very particularly suitable to incorporate into the composition of greenhouses. The haze is the ratio between the diffuse transmission and the total transmission of the glazing. The desired high transmission for these glazings is what is referred to as hemispherical light transmission (HLT, sometimes denoted by THEM), that is to say the transmission in the visible range (380-780 nm) averaged over several angles of incidence. For each angle of incidence, all the light intensity passing through the glazing is measured, whatever the angle of emergence. The hemispherical transmission is an essential feature of this type of glazing for the desired application and it is necessary that the glazing has substantially the same HLT after deposition of the scattering texture with respect to an untextured flat glass of the same nature and the same surface density.

For some years, textured glazings, the texture of which is obtained by rolling, have been well known but have been used in other technical fields such as photovoltaics. However, the current textured glasses used in photovoltaics are configured to have a very high light transmission compared with the same untextured glass without generally taking into account the effects of scattering of the light transmitted by said texturing, which may this time have a negative impact for horticultural production.

The textured glasses according to the invention are on the contrary configured to scatter the light within the greenhouse, which means a positive impact for horticultural production as indicated previously. Specifically, the scattering effect prevents hotspots on the plants and enables a better penetration of the light into all the zones of the greenhouse and ultimately the obtaining of a more uniform lighting.

The applicant company has already developed a textured glass intended more particularly for use for horticultural greenhouses, as described in patent application WO 2016/170261. The texturing of the glazing was thus adapted to such a use, and makes it possible in particular to obtain a high haze, while retaining an HLT substantially equal to that of an identical but texture-free glass. Such a glazing does not however describe means for efficiently retaining heat in the greenhouse, in particular during periods when it is cold outside.

Furthermore and very particularly in countries with a temperate climate, in which the outside temperatures may be relatively cold for a large part of the year, the thermal insulation of the greenhouses is also essential for the optimization of their efficiency, irrespective of the season. Such thermal insulation is generally measured by the heat transfer coefficient U (or K) of the glazing as defined in the standard NF EN 673 (2011) or in the reference publication “Vitrages a isolation thermique renforcée [Glazings with increased thermal insulation], Les techniques de l'ingenieur, BE 9 080”.

With this in mind, the use of double glazings (DGU for Double Glass Unit) would appear the most appropriate for very substantially increasing the thermal insulation of the greenhouse. DGUs with high light transmission could therefore be envisaged. Nevertheless, a DGU has several drawbacks: it is heavy, it is more expensive and above all it substantially reduces the light transmission with respect to a single glazing (SGU for Single Glass Unit). The present invention thus relates to such single glazings SGU.

There is therefore currently a need, in the specific field of glazings for a horticultural greenhouse, for a single glazing that simultaneously has a high degree of haze, a high hemispherical light transmission, and a good thermal insulation making it possible to retain heat in the greenhouse.

The objective of the present invention is to propose a glazing that meets such specifications and such a need.

More specifically, the present invention relates to a glazing comprising a glass substrate on which is deposited in succession, from a first surface of said substrate:
a first coating comprising a layer having infrared-reflecting properties, very particularly the wavelength of which is between 3 and 50 micrometers, or a set of layers, at least one layer of which has infrared-reflecting properties,
a second coating on top of said first coating, comprising an organic or mineral layer, said second coating having a relief texture, said texture being such that the mean slope Pₘ of said textured face is less than or equal to 15° and the percentage of the surface having a slope of greater than 5° is greater than 5%, preferably greater than or equal to 10%.

According to the invention, the second coating is advantageously textured on the surface (or the face) opposite the surface thereof in contact with said first coating.

For the purposes of the present invention, “infrared radiation” is understood to mean radiation having a wavelength between 1 and 50 micrometers. According to preferred but nonlimiting embodiments of the present invention:
the mean slope Pₘ of the textured face is less than 12° and more preferably is less than 10°, or less than 8°, or even very preferentially is less than 6°,
the mean slope Pₘ of the textured face is greater than 1° and more preferably is greater than 2°, or greater than 3°,
the percentage of the surface having a slope greater than 5° is greater than 10%, or greater than 15%, and more preferably is greater than 20%, or even greater than 30%, or greater than 40%, or very preferentially greater than 50%. The percentage of the surface having a slope less than or equal to 5° is as large as possible (ideal value of 100%) but may however, and without departing from the scope of the invention, also be less than 100%, or less than 90% or even less than 80%, 70% or 60%.
The haze, as measured over an angle of 2.5°, is greater than 10%, or greater than 15%, greater than 20%, or even greater than 30%, or even greater than 40%. According to one advantageous embodiment, the haze is greater than 50%, or greater than 60% or even greater than 80%. The haze is, according to the invention, as large as possible (ideal value of 100%) but may be less than 100%, or less than 90%, or less than 85% without departing from the scope of the invention.
The ratio between the hemispherical light transmission (HLT) of the glazing comprising the second coating and the HLT of the glazing before the deposition of the second coating is greater than 0.8, more preferably is greater than 0.9, and very preferably is greater than 0.95. Ideally, this ratio is substantially equal to 1.
The glass substrate is a glass that is untextured on the face comprising said first and second coatings. For example, the glass substrate is a float glass, the initial surface of which has not undergone any texturing treatment or treatment that aims to accentuate the roughness thereof, before the deposition of the first coating.
The layer(s) having infrared-reflecting properties in the first coating is (are) based on silver.
The first coating consists of a stack comprising at least one silver-based layer and dielectric layers.
The first coating has a thickness of between 5 nanometers and 1 micrometer, in particular between 20 and 500 nm.
The textured second coating is an organic layer. The organic layer may in particular consist of a polymer selected from a polyvinylidene chloride, a styrene-butadiene copolymer, a polyacrylonitrile, a polymethacrylonitrile or else a polycycloolefin or a polypropylene.
The textured second coating is a layer of a mineral material, said mineral material preferably being selected from oxides or nitrides. The textured coating may in particular be a layer based on silicon oxide.
The refractive index of the material forming the texture is within the range extending from 1.40 to 1.80 at 587 nm, preferably ranging from 1.40 to 1.65 at 587 nm.
The mean thickness of the second coating is between 1 and 50 micrometers, preferably between 1 and 10 micrometers.
The roughness of the textured surface of the second coating is such that the mean Rₛₘ thereof is between 10 and 100 micrometers.
The roughness of the textured surface of the second coating is such that the mean Rₐ thereof is between 0.5 and 5 micrometers.
The texture comprises contiguous patterns with a size within the range extending from 10 to 100 micrometers.
Said glazing further comprises an antireflection coating on one or both faces thereof.
The second main face of the glazing also has a texture, identical to or different from that printed on the second coating. The texture of the second main face may advantageously assume all the features described previously, in particular a mean slope Pₘ of the textured face of less than or equal to 15° and a percentage of the textured surface having a slope of greater than 5° of greater than 5%.

The invention also relates to a horticultural greenhouse equipped with at least one glazing as described previously.

Finally, the invention relates to a first process for manufacturing such a glazing which comprises the following steps:

depositing, on a glass substrate, a first coating comprising a layer having infrared-reflecting properties or a set of layers, at least one layer of which has infrared-reflecting properties, preferably by sputtering, said layer preferably being based on silver,

depositing, on the first coating obtained after the preceding step, a second coating consisting of a mineral layer having a thickness in particular of between 1 and 30 micrometers,

texturing said second coating, in particular by a crimping process, rolling process or by acid attack, preferably by a rolling process,

preferably tempering heat treatment of the glazing.

An alternative process for manufacturing a glazing according to the invention comprises the following steps:

depositing, on a glass substrate, a first coating comprising a layer having infrared-reflecting properties or a set of layers, at least one layer of which has infrared-reflecting properties, preferably by sputtering, said layer preferably being based on silver,

tempering heat treatment of the glazing,

depositing a second coating consisting of an organic layer preferably having a thickness of between 1 and 10 micrometers,

texturing said second coating, in particular by a crimping process, rolling process or etching process in particular using a preprinted roller, or by acid attack, preferably by a rolling process.

According to advantageous embodiments of the present invention, use is made, as substrate, of a weakly absorbent glass matrix such as the Diamant® or else Albarino® glass sold by the applicant company. In particular, use is made of a glass, the HLT of which is greater than 78%, preferably greater than 79%, or greater than 80%.

The degree of haze of the glazing according to the invention, as measured according to an angle of 2.5° on a Byk-Gardner Hazemeter is preferably greater than 50%, preferably greater than 60%, more preferably greater than 70%, or even greater than 80%. The measurement may in particular be carried out according to the principles described in the ISO 13468 standard (illuminant D65).

For the purposes of the present invention and within the context of the present application (and in particular in the examples), the HLT is measured according to the methods described in detail in the article “Transvision: A light transmission measurement system for greenhouse covering materials” published in the proceedings of “Proc 7th IS on light in Horticultural Systems, Eds: S. Hemming and E. Heuvelink, Acta Hort.956, ISHS 2012”.

The textured surface of the glazing according to the invention enables the scattering of the light, the surface having a mean slope Pₘ of a few degrees, i.e. typically less than or equal to 15° within the meaning described previously.

For the purposes of the present invention, the measurement of a degree of haze according to an angle of 2.5° means that the degree of haze is measured by the ratio between:
the amount of transmitted light scattered beyond a cone with a half angle of 2.5° about the normal to the surface of the glazing and
the total amount of light transmitted through the glazing.

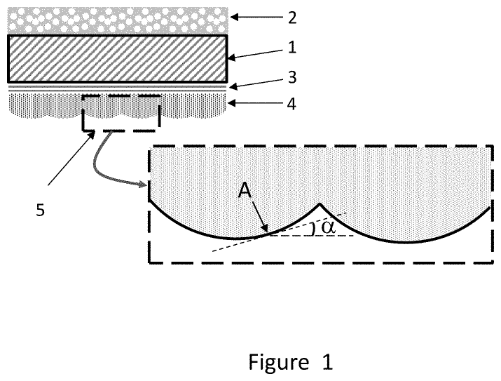

Represented in the appended FIG. 1, purely by way of illustration, is a diagram that enables a better understanding of the measurement of the haze according to the invention. The slope at a point A of the textured surface of the glazing corresponds to the angle alpha (a) formed between the plane tangent to this point and the general plane of the support sheet (here the face of the glass substrate). The measurement of the slope at point A is carried out using the measurement of the variation in height in the vicinity of this point and relative to the general plane of the sheet. A person skilled in the art knows the devices (or profilometers) capable of carrying out these height measurements. In particular, the measurements were carried out within the context of the present invention by means of a MIME profilometer, using chromatic confocal technology. The measurement of the mean slope Pₘ of the surface and of the percentage of the surface having a slope of greater than 5° is determined from the measurement of slopes at points distributed over a square mesh with a period of 1 micrometer. The mean of the slope of all these points is then calculated. On the basis of the same measurement of the profile of the texture of the second coating, it is also possible to calculate the percentage of the surface having a slope of greater than 5°.

The textured surface according to the invention in particular enables the scattering of the light and the appearance of haze, the surface having, with this in mind, a mean slope Pₘ of a few degrees, i.e. equal to or less than 15°.

In order to obtain a texture similar to the one desired, preferably patterns having a size of the order of 10 to 100 micrometers are produced. The size is understood to mean the diameter of the smallest circle containing the pattern. Preferably, the patterns are contiguous.

It is recalled that the R_{Sm} (mean period or mean pitch) of a profile (i.e. along a line segment) of a surface is defined by the relationship:

$${R}_{s m} = \frac{1}{n} {\sum }_{i = 1}^{i = n} Si = \frac{{S}_{1} + {S}_{2} + … + {S}_{n}}{n}$$

in which Sᵢ is the distance between two upward crossings through zero (median line), n+1 being the number of upward zero crossings in the profile in question. For further details, reference could also be made to the ISO 4287 (1997) standard. This parameter R_{Sm} is representative of the distance between peaks, i.e. of the pitch of the texture parallel to the general plane of the sheet. The R_{Sm} values are given after use of Gaussian filters with cut-offs (or base lengths) at 0.8 micrometers and 250 micrometers (suppression of the periods of less than 0.8 micrometers and greater than 250 micrometers). The R_{Sm} measurements are carried out over a distance of at least 1250 micrometers. For any point of the textured surface, the R_{Sm} about said point corresponds to the arithmetic mean of the R_{Sm} values for 10 profiles starting in a star shape from the point in question. For the calculation of the R_{Sm} about a point, the values greater than or equal to 1250 micrometers are removed. This avoids taking into account the profiles in certain directing lines of particular textures, such as that of parallel prisms or of straight lines between aligned pyramids (infinite or noncalculable R_{Sm} value). The mean R_{Sm} of a textured surface is defined by calculating the arithmetic mean of the R_{Sm} values about a point, the points being chosen on a square grid with a pitch of 5 cm.

Preferably, the mean R_{Sm} of the textured surface is within the range extending from 10 micrometers to 100 micrometers and preferably within the range extending from 20 to 80 micrometers and even within the range extending from 30 micrometers to 70 micrometers or within the range extending from 40 micrometers to 60 micrometers. More preferably, the R_{Sm} about any point of the textured surface is within the range extending from 10 micrometers to 100 micrometers and preferably within the range extending from 20 to 80 micrometers and even within the range extending from 30 micrometers to 70 micrometers or even within the range extending from 40 micrometers to 60 micrometers.

The patterns of the texture may be parallel linear patterns such as parallel prisms or be patterns that can be inscribed in a circle such as cones or pyramids.

The patterns of the texture have for example a mean depth (or mean height) between around 0.5 and 3 micrometers, on the basis of the same measurement conditions as those described previously and according to the ISO 4287 (1997) standard.

The first coating according to the invention comprising at least one layer having infrared-reflecting properties, in particular for reflecting thermal infrared radiation (i.e. between 3 and 50 micrometers) or a set of layers, at least one layer of which has infrared-reflecting properties, in particular thermal infrared-reflecting properties. It preferably consists of a stack of layers comprising at least one silver-based layer and preferably at least two, or three silver layers, separated by layers of dielectric materials. The normal emissivity of said first coating (i.e. of the surface of a glazing coated with such a coating), within the meaning described in the EN 12898 (2001) standard, is preferably less than 0.15, more preferably less than 0.1 and very preferably less than 0.05. Said first stack also comprises layers of dielectric materials, of which the indices, the location in the series of layers and the thicknesses are optimized to give the glazing an optimal, i.e. maximum, HLT, according to techniques well known in the field. Its thickness varies from a few nanometers to a few hundred nanometers, for example between 10 and 300 nanometers.

It is for example a low-emissivity stack comprising a silver-based functional layer and sold by the applicant company under the reference Eclaz II, of which the normal emissivity is 3% and the HLT is 81% when it is deposited on a clear glass such as the Planiclear glass also sold by the applicant company. Provided with such a layer, the heat transfer coefficient U of the single glazing according to the invention is in general less than 4 W/m²·K, and preferably less than 3.5 W/m²·K.

The second coating may be, according to the invention, of organic nature or of mineral nature.

According to a first mode, this coating is of organic nature. This coating may advantageously be a polymer. The chosen material is for example a polymer selected from PVDC (polyvinylidene chloride) as described in application WO 2016/097599, a styrene-butadiene copolymer as described in application WO 2017/103465, polyacrylonitrile (PAN) or polymethacrylonitrile (PMAN) as described in application WO 2013/089185 or else polycycloolefin or polypropylene, or generally, any polymer sufficiently mechanically strong and chemically resistant to preserve the underlying first stack and in particular the infrared-reflecting layers of such stacks, in particular the silver-based layer(s).

The polymer is advantageously chosen to be transparent in the visible range (380-780 nm) and preferably also transparent in the near infrared (780-2500 nm). Said coating is, according to the invention, advantageously not very or not at all absorbent in the thermal infrared range (i.e. having a wavelength between 3 and 50 microns).

According to an alternative mode, the coating is of mineral nature. Such a coating may for example be based on silicon oxide, in particular obtained by a sol-gel process followed by heating, or else any other dielectric mineral compound that is transparent in the visible range (380-780 nm) and preferably also transparent in the near infrared (780-2500 nm). Said coating is, according to the invention, advantageously not very or not at all absorbent in the thermal infrared range (i.e. having a wavelength between 3 and 50 microns).

The thickness of the second coating is preferably less than 10 micrometers, and more preferably less than 5 micrometers. In particular, in the case where the second coating is of mineral nature, its thickness may even be less than 3 micrometers or even less than 2 micrometers.

After deposition of the second coating, the latter is textured within the meaning of the present invention, so as to increase the haze thereof according to the criteria defined previously, without substantially reducing the HLT thereof.

Such a texture of the organic or mineral protective second coating may be obtained by any known means, in particular by embossing, by rolling, by etching (in particular using a preprinted roller), by thermoforming, by crimping, or else by acid attack.

Advantageously however, the texture is obtained by etching the surface of said second coating using a roller, the patterns of which are printed in the negative form, optionally with a step of heating its surface until a softening temperature at least at the surface of said second coating is reached or alternatively in order to densify said coating (in particular in the case of a sol-gel layer).

The glazing may also comprise one or more antireflective layers for increasing the light transmission (HLT). The antireflective coating may be deposited on one or both faces of the glazing, and in particular on the untextured face. This antireflective effect may be obtained by the deposition of a layer or several layers forming a stack, by chemical attack or any other suitable technique. The antireflective effect is chosen in order to be effective at the 400-700 nm wavelengths. An antireflective coating (antireflective layer or stack of layers having an antireflective effect) generally has a thickness within the range extending from 10 to 500 nm. Such antireflective layers are in particular advantageously chosen from porous silicon oxide layers, in particular of the type of those described in publication WO 2008/059170.

The invention is of use for serving as glazing that allows the passage of light for greenhouses for horticulture, and also for other applications requiring a high HLT and a high haze such as a horticultural greenhouse but also a conservatory, a reception hall or a public space.

FIG. 1 depicts an example of a glazing according to the invention: The glazing comprises a transparent substrate 1, the HLT light transmission of which is greater than 80%, in particular greater than 82% or even greater than 83%. In particular, it is an extra-clear float glass sold by the applicant company under the reference Diamant®. Deposited on a first face of this glass substrate is an antireflection coating 2 of any known type, in particular based on porous silicon oxide. Present in succession on the other face of the substrate are a “low-e” first coating 3 comprising at least one layer that reflects infrared radiation, in particular thermal infrared radiation, in particular a silver-based layer. Preferably, the stack has a normal emissivity of less than 0.1, or even less than 0.05. This first coating is chosen on the one hand in order to impart thermal insulation properties to the glazing, without substantially reducing the HLT thereof, according to the principles described previously. A mineral-based or organic-based protective second coating 4 as described previously is present on top of the first coating, with reference to the surface of the substrate. This protective layer comprises, on the opposite surface (face), a texturing 5 specifically suitable for bringing the degree of haze to a value at least equal to 10% and preferably greater than 50%, within the meaning described previously, while retaining an HLT value equal to at least 80% and preferably equal to at least 85%, or 90% of the initial value of the glazing (provided with the first coating) before the deposition of this protective second coating.

Thus a glazing is obtained that simultaneously has good thermal insulation properties and a high degree of haze, while retaining a high light transmission HLT and ultimately a glazing is obtained it is perfectly suitable for use in a horticultural greenhouse.

A nonlimiting exemplary embodiment of such a glazing is given below:

In this example, a glazing as described previously is printed by rolling, said glazing comprising:
a Planiclear® clear glass substrate sold by the company Saint-Gobain Glass France,
a first coating consisting of a silver-based Eclaz II stack sold by the company Saint-Gobain Glass France,
a second coating of an organic polymer based on styrene-butadiene copolymer as described in application WO 2017/103465, having a total thickness equal to around 5 micrometers.

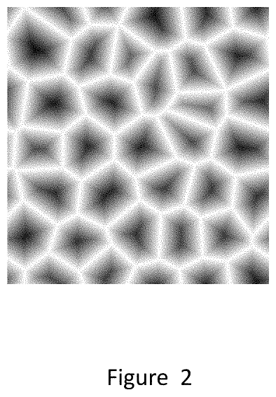

Printed, by means of a printed roller, on the outer face of this second coating is a texture consisting of a repetition of recessed irregular-based pyramidal patterns of different sizes, as represented in appended FIG. 2. In FIG. 2, the depth is the difference in height between the lightest and darkest points of this figure. Table 1 below indicates the main values of the texture induced on the second coating:

TABLE 1

| Depth | Mean Rₛₘ | Pm | Haze | % surface with |
|---|---|---|---|---|
| (μm) | (μm) | (°) | (%) | slope >5° |
| 1.5 | 50 | 3.8° | 60 | 100 |

It is measured that the HLT is reduced by the order of 5% relative to the initial glass substrate without the two coatings. The heat transfer coefficient U of the glazing according to the invention is 3.4 W/m²·K, whereas it was 5.8 W/m²·K for the bare substrate. The degree of haze is itself of the order of 60%, which ensures an optimal scattering of the light in the greenhouse.

Given below are the various methods for manufacturing a glazing according to the invention, in connection with the appended FIG. 3:

According to a first step, an extra-clear float substrate, for example a Diamant® substrate from the applicant company, is selected. A first coating having infrared-reflecting properties, known in the field under the name “low-e” coating, is deposited on the extra-clear substrate by the well-known techniques of magnetron sputtering. This stack of layers comprises at least one layer based on silver, preferably made of silver, and the stack is configured in such a way that the HLT of the substrate-first coating assembly is maximized. More preferably, the stack is configured in order to minimize the value of the heat transfer coefficient U, in particular by the selection of a stack, the value of the normal emissivity of which is minimal, within the meaning described previously. Advantageously, the low-e stack selected is of the type “to be tempered”, and additionally has no significant variation in its colorimetry during the tempering of the glazing. According to an advantageous but optional mode, it is possible to deposit on this magnetron stack a temporary protective coating is applied to the coating having infrared-reflecting properties. This layer is for example deposited by a liquid route and is for example derived from a composition based on methacrylates (easypro layer) as described in application WO 2015/019022.

### A—According to a First Embodiment

according to a second step:

In a second step which may in particular is carried out off-line with respect to the glazing obtained according to the preceding step, for example at another site, the glass is cut to the desired size, the antireflection layer (or precursor of said layer, in particular a silica gel according to a “wet deposition” process) is optionally deposited on the opposite face in accordance with the production already described in connection with FIG. 1. A tempering of the glazing is carried out under customary conditions (for example heating at 620° C. for 5 minutes followed by rapid cooling). The antireflection layer becomes porous and the low-e stack achieves the desired properties.
according to a third step:

Immediately after the tempering step, a permanent protective coating of the low-e stack is deposited by means of a roller having the required texture to give the glazing a relief that generates haze without substantially reducing the HLT thereof, optionally with an intermediate or final firing in order to harden the material. The chosen material is for example a polymer selected from PVDC (polyvinylidene chloride) as described in application WO2016/097599, a styrene-butadiene copolymer as described in application WO 2017/103465, polyacrylonitrile (PAN) or polymethacrylonitrile (PMAN) as described in application WO 2013/089185 or else polycycloolefin or polypropylene.

B—According to a second embodiment
in a second step:

A permanent protective coating is directly applied on the coating with infrared-reflecting properties. This layer is for example a sol-gel silica layer deposited by a liquid route which is then polymerized and subjected to a hardening treatment by heat treatment, then (or at the same time) textured according to the conventional etching printing techniques. This protective layer is transparent to thermal IR, temperable and has the required texture to give the glazing a relief that generates haze without substantially reducing the HLT thereof.
according to a third step:

In a third step, which may in particular be carried out off-line with respect to the glazing obtained according to the preceding step, for example at another site, the glass is cut to the desired size, the antireflection layer (for example made of porous silica as described in the publication WO 2008/059170) is deposited on the opposite face in accordance with the production already described in connection with FIG. 1 and a tempering of the glazing is carried out under the customary conditions. The antireflection layer becomes porous and the low-e stack achieves the desired properties.

In the end, a glazing according to the invention and capable of being advantageously used in horticultural greenhouses is obtained.

1. A glazing, comprising a glass substrate on which is deposited in succession, from a first surface of said substrate:
a first coating comprising a layer having infrared-reflecting properties or a set of layers, at least one layer of which has infrared-reflecting properties,
a second coating positioned on top of said first coating comprising an organic or mineral layer, said second coating having a relief texture, said texture being such that its mean slope Pₘ is less than or equal to 15°, and such that the percentage of the textured surface having a slope of greater than 5° is greater than 5%.

2. The glazing as claimed in claim 1, having a haze, as measured according to an angle of 2.5°, of greater than 10%.

3. The glazing as claimed in claim 1, wherein a ratio between the hemispherical light transmission (HLT) of the glazing comprising the second coating and the hemispherical light transmission of the glazing before the deposition of the second coating is greater than 0.8.

4. The glazing as claimed in claim 1, wherein the glass substrate is a glass that is untextured on the face comprising said first and second coatings.

5. The glazing as claimed in claim 1, wherein the textured second coating is an organic layer.

6. The glazing as claimed in claim 5, wherein the organic layer consists of a polymer selected from the group consisting of a polyvinylidene chloride, a styrene-butadiene copolymer, a polyacrylonitrile, a polymethacrylonitrile, a polycycloolefin and a polypropylene.

7. The glazing as claimed in claim 1, wherein the textured second coating is a layer of a mineral material.

8. The glazing as claimed in claim 7, wherein the textured coating is a layer based on silicon oxide.

9. The glazing as claimed in claim 1, wherein the layer having infrared-reflecting properties or the at least one layer having infrared-reflecting properties is based on silver.

10. The glazing as claimed in claim 1, wherein the refractive index of the material forming the second coating is within the range extending from 1.40 to 1.80 at 587 nm.

11. The glazing as claimed in claim 1, wherein a mean thickness of said second coating is between 1 and 50 micrometers.

12. The glazing as claimed in claim 1, wherein a roughness of the textured surface of the second coating is such that the mean Rₛₘ is between 10 and 100 micrometers.

13. The glazing as claimed in claim 1, wherein a roughness of the textured surface of the second coating is such that its mean Rₐ is between 0.5 and 5 micrometers.

14. The glazing as claimed in claim 1, wherein the texture comprises contiguous patterns with a size within the range extending from 10 to 100 micrometers.

15. The glazing as claimed in claim 1, further comprising an antireflection coating on one or both faces thereof.

16. The glazing as claimed in claim 1, wherein the second main face thereof also has a texture, identical to or different from that printed on the second coating.

17. The glazing as claimed in claim 16, wherein the texture of the second main face has a mean slope Pm of the textured face is less than or equal to 15° and the percentage of the textured surface having a slope of greater than 5° is greater than 5%.

18. A horticultural greenhouse comprising at least one glazing as claimed in claim 1.

19. A process for manufacturing a glazing as claimed in claim 1:
depositing, on a glass substrate, a first coating comprising a layer having infrared-reflecting properties or a set of layers, at least one layer of which has infrared-reflecting properties,
depositing, on the first coating that has been deposited, a second coating consisting of a mineral layer,
texturing said second coating.

20. A process for manufacturing a glazing as claimed in claim 1 comprising:
depositing, on a glass substrate, a first coating comprising a layer having infrared-reflecting properties or a set of layers, at least one layer of which has infrared-reflecting properties,
tempering heat treatment of the glazing,
depositing a second coating consisting of an organic layer,
texturing said second coating.
